(19) United States
(12) Patent Application Publication
(10) Pub. No.: US 2020/0162134 A1
(43) Pub. Date: May 21, 2020

(54) USER EQUIPMENT AND METHOD OF CHANNEL STATE INFORMATION (CSI) ACQUISITION

(71) Applicant: NTT DOCOMO, INC., Tokyo (JP)

(72) Inventors: Yuichi Kakishima, Tokyo (JP); Chongning Na, Tokyo (JP); Min Liu, Tokyo (JP); Xin Wang, Tokyo (JP); Satoshi Nagata, Tokyo (JP)

(73) Assignee: NTT DOCOMO, INC., Tokyo (JP)

(21) Appl. No.: 16/610,848

(22) PCT Filed: May 4, 2018
(86) PCT No.: PCT/US2018/031071

§ 371 Date: Nov. 4, 2019

Related U.S. Application Data
(60) Provisional application No. 62/501,441, filed on May 4, 2017.

(51) Int. Cl. H04B 7/0417; H04L 5/00; H04W 72/04

(52) U.S. Cl. CPC H04B 7/0417; H04W 72/04; H04L 5/0048

(57) ABSTRACT

A user equipment (UE) includes a receiver that receives, from a Transmission and Reception Point (TRP), multiple Demodulation Reference Signals (DMRSs) in adjacent resource blocks (RBs) of which a number is greater than a first predetermined value, a processor that measures Channel State Information (CSI) using the received DMRSs, and a transmitter that performs CSI reporting based on the CSI.

### TECHNICAL FIELD

The present invention generally relates to a user equipment (UE) and a method of Channel State Information (CSI) acquisition in a wireless communication system.

### BACKGROUND

Long Term Evolution (LTE)/LTE-Advanced (LTE-A) supports only wideband and subband Channel State Information (CSI) feedback. However, for DMRS based CSI acquisition and feedback, a frequency granularity is required to be aligned with a scheduled granularity, e.g., because DM-RS is multiplexed in the limited frequency bandwidth and different precoding resource block groups (PRGs) may use different precoders. Furthermore, accuracy of DMRS based CSI depends on the Transmission Time Interval (TTI) and the number of adjacent Resource Blocks (RBs).

In New Radio (NR) system, it may be required to further elaborate the frequency granularity of DMRS based CSI acquisition. Furthermore, further restriction on the DMRS based CSI acquisition may be required to achieve accuracy measurement. However, detailed design of the DMRS based CSI acquisition scheme for NR has not been determined in the 3GPP standard.

### CITATION LIST

### Non-Patent Reference

Non-Patent Reference 1: 3GPP, TS 36.211 V 14.2.0
Non-Patent Reference 2: 3GPP, TS 36.213 V14.2.0

### SUMMARY OF THE INVENTION

One or more embodiments of the present invention relate to a user equipment (UE) that includes a receiver that receives, from a Transmission and Reception Point (TRP), multiple Demodulation Reference Signals (DMRSs) in adjacent resource blocks (RBs) of which a number is greater than a first predetermined value, a processor that measures Channel State Information (CSI) using the received DMRSs, and a transmitter that performs CSI reporting based on the CSI.

One or more embodiments of the present invention relate to a method of Channel State Information (CSI) acquisition in a wireless communication system, the method that includes transmitting, from a Transmission and Reception Point (TRP) to a user equipment (UE), multiple Demodulation Reference Signals (DMRSs) in adjacent resource blocks (RBs) of which a number is greater than a first predetermined value, measuring, with the UE, Channel State Information (CSI) using the received DMRSs, and performing, with the UE, CSI reporting based on the CSI.

One or more embodiments of the present invention can provide a method of a DMRS based CSI acquisition that is not determined in the 3GPP standard.

Other embodiments and advantages of the present invention will be recognized from the description and figures.

### BRIEF DESCRIPTION OF THE DRAWINGS

FIG. 1 is a diagram showing a configuration of a wireless communication system according to one or more embodiments of the present invention.

FIG. 2 is a sequence diagram showing an example of an operation a DMRS based CSI acquisition scheme.

FIG. 3 is a sequence diagram showing an example of an operation of a DMRS based CSI acquisition scheme in which a DL grant that triggers CSI reporting according to one or more embodiments of the present invention.

FIG. 4 is a sequence diagram showing an example of an operation of a DMRS based CSI acquisition scheme in which a UL grant that triggers CSI reporting according to one or more embodiments of the present invention.

FIG. 5 is a sequence diagram showing an example of an example of contiguous DMRSs with adjacent RBs according to one or more embodiments of a first example of the present invention.

FIG. 6 is a sequence diagram showing an example of an operation of a DMRS based CSI acquisition scheme according to one or more embodiments of the first example of the present invention.

FIG. 7 is a diagram showing an example of an operation of a UE according to one or more embodiments of the first example of the present invention.

FIG. 8 is a diagram showing an example of an operation of a UE according to one or more embodiments of the first example of the present invention.

FIG. 9 is a diagram showing an example of an operation of a UE according to one or more embodiments of the first example of the present invention.

FIG. 10 is a diagram showing an example of an operation of a UE according to one or more embodiments of the first example of the present invention.

FIG. 11 is a diagram showing a schematic configuration of the TRP according to one or more embodiments of the present invention.

FIG. 12 is a diagram showing a schematic configuration of the UE according to one or more embodiments of the present invention.

### DETAILED DESCRIPTION

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

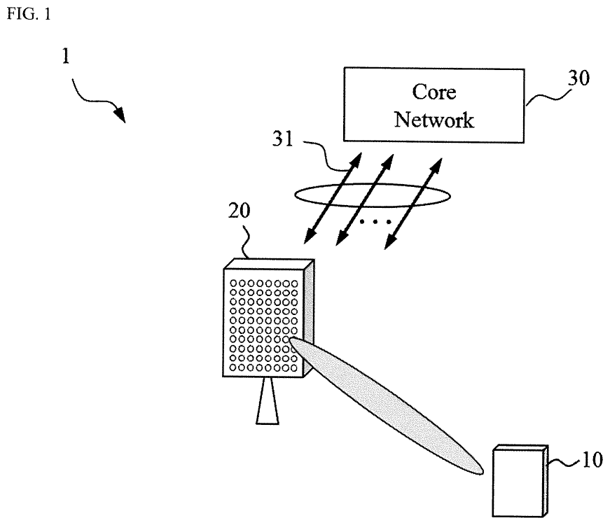

FIG. 1 is a wireless communications system 1 according to one or more embodiments of the present invention. The wireless communication system 1 includes a user equipment (UE) 10, a transmission and reception point (TRP) 20, and a core network 30. The wireless communication system 1 may be a New Radio (NR) system. The wireless communication system 1 is not limited to the specific configurations described herein and may be any type of wireless communication system such as an LTE/LTE-Advanced (LTE-A) system.

The TRP 20 may communicate uplink (UL) and downlink (DL) signals with the UE 10 in a cell of the TRP 20. The DL and UL signals may include control information and user data. The TRP 20 may communicate DL and UL signals with the core network 30 through backhaul links 31. The TRP 20 may be referred to as a base station (BS). The TRP 20 may be gNodeB (gNB).

The TRP 20 includes antennas, a communication interface to communicate with an adjacent TRP 20 (for example, X2 interface), a communication interface to communicate with the core network 30 (for example, S1 interface), and a CPU (Central Processing Unit) such as a processor or a circuit to process transmitted and received signals with the UE 10. Operations of the TRP 20 may be implemented by the processor processing or executing data and programs stored in a memory. However, the TRP 20 is not limited to the hardware configuration set forth above and may be realized by other appropriate hardware configurations as understood by those of ordinary skill in the art. Numerous TRPs 20 may be disposed so as to cover a broader service area of the wireless communication system 1.

The UE 10 may communicate DL and UL signals that include control information and user data with the TRP 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the TRP 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

According to one or more embodiments of the present invention, CSI measurement and reporting may be performed based on frequency/time/density restricted Reference Signal (RS). In one or more embodiments of the present invention, the RS may be a Zero Power (ZP)/Non Zero Power (NZP) CSI-RS, DMRS, and Sounding Reference Signal (SRS).

The present disclosure will describe examples of CSI measurement and reporting based on the DMRS as an example of the RS; however, one or more embodiments of the present invention may apply to another RS such as ZP/NZP CSI-RS, DMRS, SRS, and a newly defined reference signal.

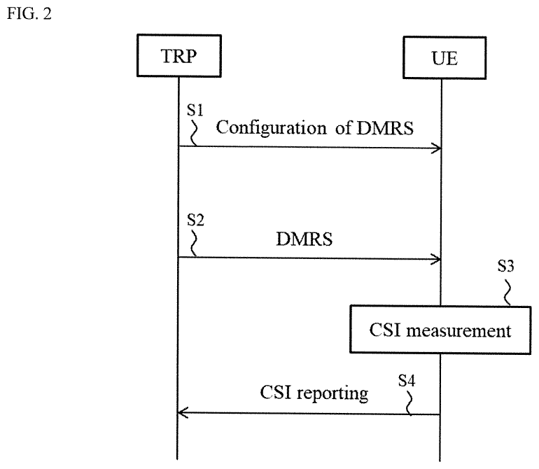

First, the conventional DMRS based CSI measurement and reporting will be explained below, with reference to FIG. 2. As shown in FIG. 2, at step S1, a TRP transmits configuration information indicating a configuration of a DMRS to UE. At step S2, the TRP transmits the DMRS to the UE. At step S3, the UE performs CSI measurement based on the DMRS using the configuration of the DMRS. At step S4, the UE performs CSI reporting based on a result of the CSI measurement.

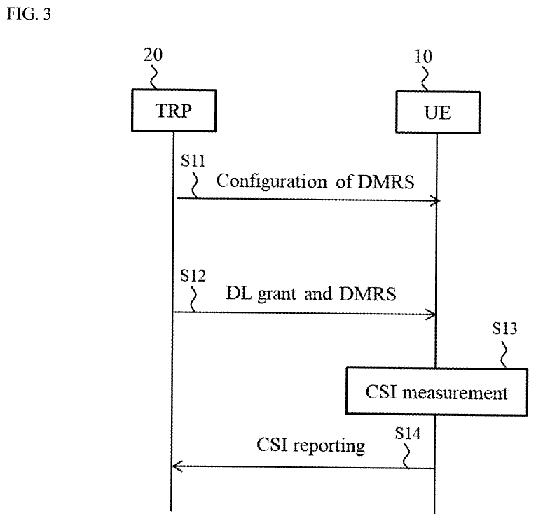

On the other hand, according to one or more embodiments of the present invention, in the DMRS based CSI measurement scheme, a downlink (DL) grant may trigger the CSI reporting based on the DMRS. As shown FIG. 3, at step S11, the TRP 20 may transmit configuration information indicating a configuration of a DMRS to the UE 10. At step S12, the TRP 20 may transmit both of the DL grant that triggers CSI reporting and a DMRS to the UE 10. At step S13, the UE 10 may perform CSI measurement based on the DMRS using the configuration of the DMRS. At step S14, the UE 10 may perform CSI reporting based on the DL grant. The CSI reporting may be performed using a result of the CSI measurement. The CSI reporting includes at least one of a CSI-RS resource indicator (CRI), a Rank Indicator (RI), a Precoding Matrix Indicator (PMI), a Channel Quality Indicator (CQI), and Reference Signal Received Power (RSRP).

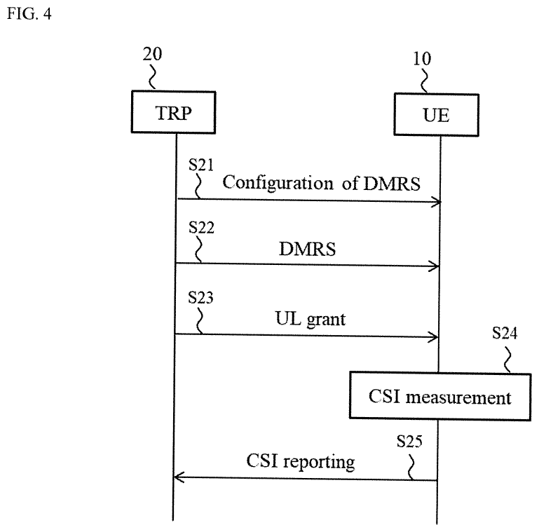

According to one or more embodiments of the present invention, in the DMRS based CSI measurement scheme, an uplink (UL) grant may trigger the CSI reporting based on the DMRS. As shown FIG. 4, at step S21, the TRP 20 may transmit configuration information indicating a configuration of the DMRS to the UE 10. At step S22, the TRP 20 may transmit the DMRS to the UE 10. At step S23, the TRP 20 may transmit the UL grant that triggers the CSI reporting. At step S24, the UE 10 may perform the CSI measurement based on the DMRS. Then, at step S25, the UE 10 may perform the CSI reporting based on the UL grant.

The DMRS is used for demodulation of a Physical Downlink Shared Channel (PDSCH). That is, the DMRS is associated with the PDSCH to be demodulated using the DMRS.

### First Example

According to one or more embodiments of a first example of the present invention, frequency domain restricted DMRS based CSI measurement and CSI reporting may be performed.

(DMRS Based CSI Measurement Restriction (MR) in Frequency Domain)

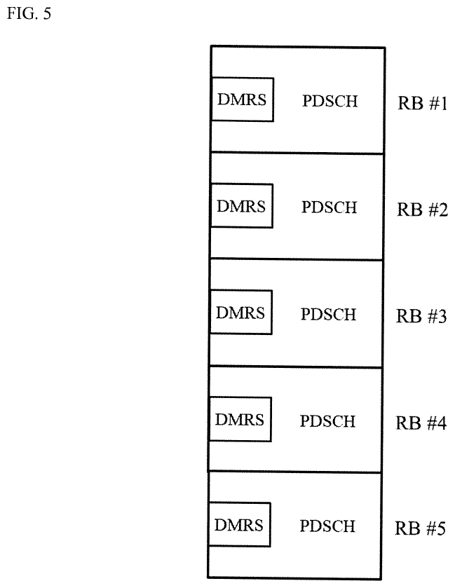

According to one or more embodiments of the first example of the present invention, the CSI may be measured and reported on contiguous DMRSs with more than “X” adjacent RBs. FIG. 5 shows an example of the contiguous DMRSs with adjacent RBs of which the number is a predetermined value “X.” As shown in FIG. 5, each of adjacent RBs (e.g., RBs #1-5) includes the DMRS and the PDSCH. Thus, the TRP 20 may transmit the contiguous DMRSs with the adjacent RBs to the UE 10. The UE 10 may measure the CSI using the contiguous DMRSs with the adjacent RBs. The value “X” is the number of RBs. For example, the value of “X” may be “5”. However, the value of “X” is not limited to 5 and may be a predetermined value which is at least two.

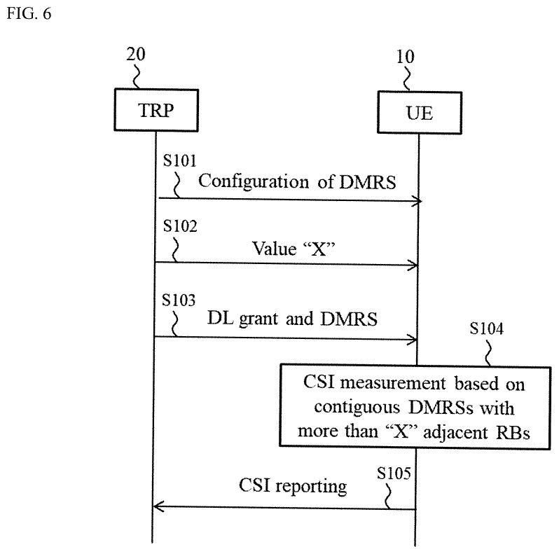

As shown in FIG. 6, at step S101, the TRP 20 may transmit configuration information that indicates a configuration of the DMRS. Then, at step S102, the TRP 20 may notify the UE 10 of the value of “X” using predetermined signaling such as Radio Resource Control (RRC) signaling. At step S103, the TRP 20 may transmit the DL grant and the DMRSs to the UE 10. At step S104, the UE 10 may perform the CSI measurement based on contiguous DMRSs with more than “X” adjacent RBs using the notified value “X”. At step S105, the UE 10 may perform the CSI reporting based on a result of the CSI measurement.

For example, the value of “X” may be indicated as an unit of precoding resource block groups (PRGs) or multiple PRGs. The PRG may be a group that consists of at least one precoding RB and a scheduling unit.

For example, the value of “X” may be indicated as an unit of resource block groups (RBGs) or multiple RBGs. The RBG may be a group that consists of at least one RB.

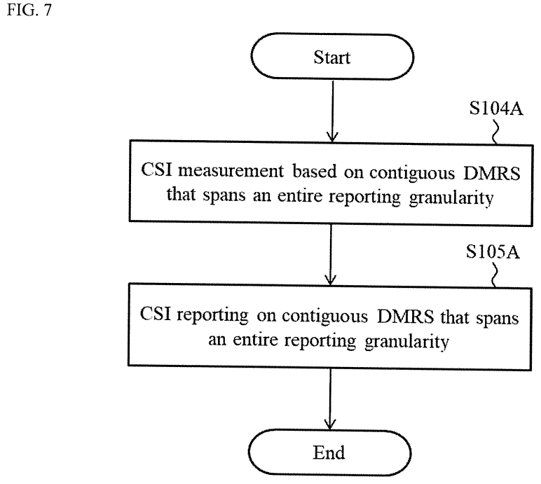

According to one or more embodiments of the first example of the present invention, as shown in FIG. 7, at step S104A, the UE 10 may perform CSI measurement based on contiguous DMRSs that spans an entire reporting granularity. At step S105A, the UE 10 may perform the CSI reporting on the contiguous DMRSs that spans an entire reporting granularity using a result of the CSI measurement. The steps S104A and S105A may be replaced with the steps S104 and S105 of FIG. 7.

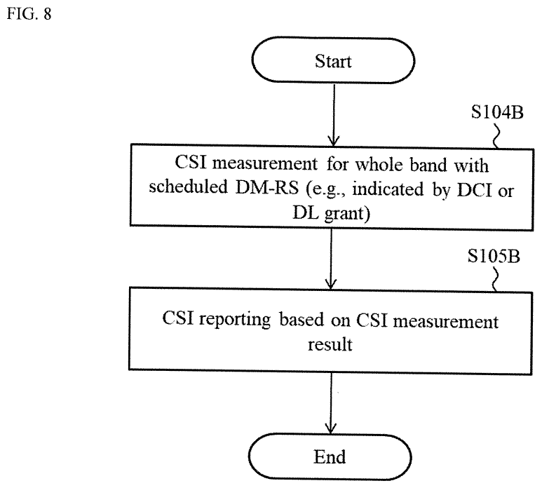

According to one or more embodiments of the first example of the present invention, as shown in FIG. 8, at step S104B, the UE 10 may perform the CSI measurement for the whole band with scheduled DMRS (e.g., indicated by DCI or DL grant). At step S105B, the UE 10 may perform the CSI reporting based on a result of the CSI measurement. The steps S104B and S105B may be replaced with the steps S104 and S105 of FIG. 7.

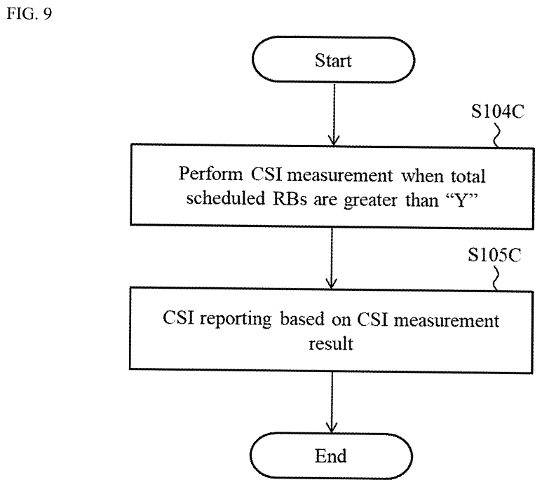

According to one or more embodiments of the first example of the present invention, as shown in FIG. 9, at step S104C, the UE 10 may perform the CSI measurements when total scheduled RBs are greater than “Y”. Then, at step S105C, the UE 10 may perform the CSI reporting based on a result of the CSI measurement. The steps S104C and S105C may be replaced with the steps S104 and S105 of FIG. 7.

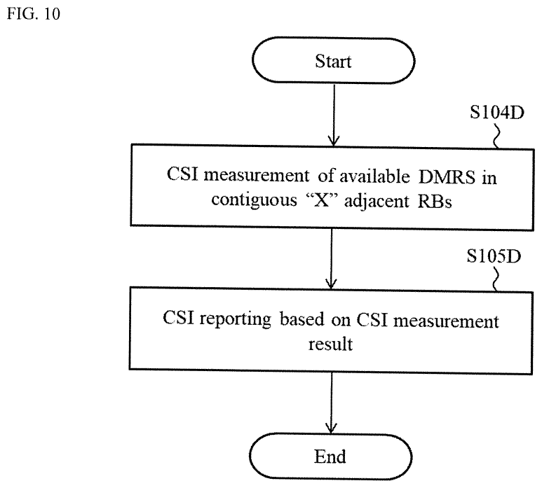

According to one or more embodiments of the first example of the present invention, as shown in FIG. 10, at step S104D, the UE 10 may perform the CSI measurement of available DMRS in contiguous “X” adjacent RBs. Then, at step S105D, the UE 10 may perform the CSI reporting based on a result of the CSI measurement. The steps S104D and S105D may be replaced with the steps S104 and S105 of FIG. 7. For example, the DMRS may be available only on some RBs.

(DMRS Based CSI Report Frequency Granularity)

In one or more embodiments of the first example of the present invention, the UE 10 may perform the following four types of CSI calculation and reporting.

In a first type “Precoding Resource Block (PRB) CSI”, for example, CQI/PMI may be calculated and reported in each PRB. For example, the RS may be other reference signals such as CSI-RS and SRS, the CSI may include a CSI-RS Resource Indicator (CRI), an SRS Resource Indicator (SRI), a CQI, Reference Signal Received Power (RSRP) or Interference Power.

In a second type “Precoding Resource Block Group (PRG) CSI”, for example, the CQI/PMI may be calculated and reported based on a PRG size. For example, the PRG size may be the number of PRGs. For example, the PRG size may be specified in advance. For example, the PRG size may be configured by the TRP 20. That is, the TRP 20 may notify the UE 10 of the PRG size.

For example, the PRG size may be specified and/or configured for a PDSCH.

For example, the PRG size may be specified and/or configured for the DMRS associated with the PDSCH to be demodulated. For example, the PRG size of the DRMS may be smaller than the PRG size of the corresponding PDSCH. The PRG size of the DRMS may be the number of PRGs having the DMRSs. For example, the PRG size of the DRMS may be larger than the PRG size of the corresponding PDSCH.

In a third type “Subband CSI”, for example, the CQI/PMI may be calculated and reported based on a subband size specified or configured by the TRP 20.

In a fourth type, for example, the CQI/PMI may be calculated and reported based on a predetermined value associated with at least one of the PRB, the PRG, and the subband. The TRP 20 may notify the UE 10 of the predetermined value.

(DMRS Based CSI Report Frequency Range)

In the DMRS based CSI reporting/indication according to one or more embodiments of the first example of the present invention, a reporting frequency range may be determined based on the configured CSI reporting mode (e.g., entire band and gNB/UE selected part bands).

In the DMRS based CSI reporting according to one or more embodiments of the first example of the present invention, the reporting frequency range may be determined based on the scheduled DMRS resources.

In the DMRS based CSI reporting according to one or more embodiments of the first example of the present invention, the reporting frequency range may be determined based on the scheduled PDSCH/Physical Uplink Shared Channel (PUSCH) frequency range.

### Second Example

According to one or more embodiments of a second example of the present invention, time Domain restricted DMRS based CSI measurement and CSI reporting may be performed.

(DMRS based CSI MR in Time Domain)

According to one or more embodiments of the second example of the present invention, the CSI may be measured and reported based on one-shot measurement.

According to one or more embodiments of the second example of the present invention, the CSI may be measured and reported based on multiple shots measurement.

In one or more embodiments of the second example of the present invention, the time range may be informed by the TRP 20.

### Third Example

According to one or more embodiments of a third example of the present invention, density restricted DMRS based CSI measurement and reporting may be performed.

According to one or more embodiments of the third example of the present invention, the CSI may be measured and reported on the DMRS if density of DMRS is larger than “Y” RE/RB/port within a given measurement range (e.g., one subband) or on whole band.

According to one or more embodiments of the third example of the present invention, CSI type A (e.g., interference covariance) may be measured and reported on DMRS if density of DMRS is larger than “Z” RE/RB/port, otherwise, CSI type B (e.g., interference power) may be measured and reported.

### Fourth Example

According to one or more embodiments of a fourth example of the present invention, priority handling between the DMRS and the CSI-RS may be applied. According to one or more embodiments of the fourth example of the present invention, for the CSI reporting, if a reference resource contains both valid CSI-RS and DMRS resources in a predetermined time/frequency reporting granularity.

According to one or more embodiments of the fourth example of the present invention, the Channel measurement and reporting may be performed based on at least one of the following:
Example 1-1: always CSI-RS;
Example 1-2: always DMRS;
Example 1-3: the RS resource that is closer to the reporting time instance;
Example 1-4: use of the DMRS if the DMRS is transmitted less than “x” milliseconds (ms) before CSI-RS;
Example 1-5: use of the DMRS if the DMRS is transmitted less than “x” ms before CSI-RS based CSI feedback;
Example 1-6: the RS resource that has a higher density per resource;
Example 1-7: the DMRS if it is triggered by DL grant otherwise CSI-RS; and
Example 1-8: Both are measured and reported. One CQI can be the base and the other can be the bias value compared to the base.

According to one or more embodiments of the fourth example of the present invention, the IM may be performed based on at least one of the following:
Example 2-1: always DMRS;
Example 2-2: the RS resource that is closer to the reporting time instance;
Example 2-3: use of the DMRS if DMRS is transmitted less than x ms before CSI-RS;
Example 2-4: use of the DMRS if DMRS is transmitted less than x ms before CSI-RS based CSI feedback;
Example 2-5: the RS resource that has a higher density per resource; and
Example 2-6: the DMRS if it is triggered by DL grant otherwise CSI-RS.

One or more embodiments of the fourth example of the present invention may apply to a method of priority handling between two types of RS. According to one or more embodiments of another example of the present invention, for the CSI reporting, if the reference resource contains both valid Type A RS and Type B RS resources in certain time/frequency reporting granularity.

According to one or more embodiments of another example of the present invention, the channel measurement and reporting may be performed based on Type A RS.

According to one or more embodiments of another example of the present invention, IM may be performed based on the following:
Example 3-1: always Type B RS;
Example 3-2: the RS resource that is closer to the reporting time instance;
Example 3-3: use of the Type B RS if Type B RS is transmitted less than x ms before Type A RS;
Example 3-4: the RS resource that has a higher density per resource; and
Example 3-5: use of the Type B RS if the Type B RS is transmitted less than x ms before Type A RS based CSI reporting.

Furthermore, in one or more embodiments of the present invention, the reference resource refers to [A] time instances before the reporting instance and [B] frequency instances.

(Configuration of TRP)

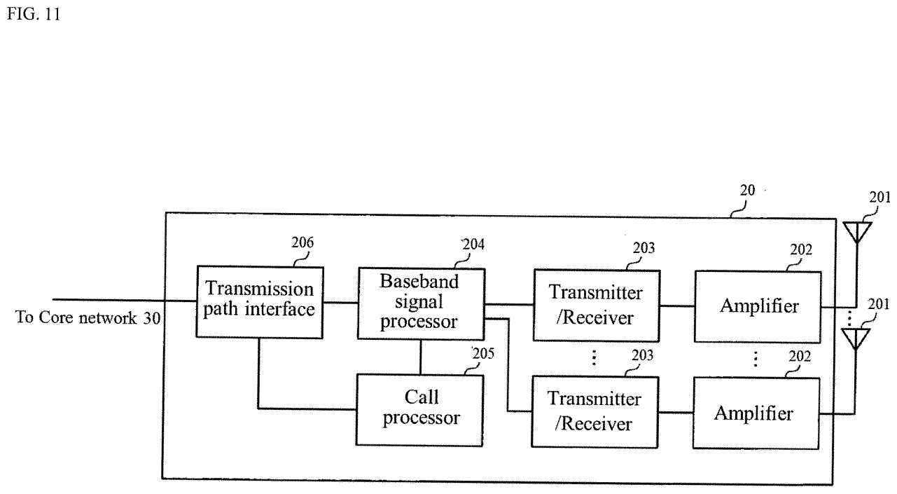

The TRP 20 according to one or more embodiments of the present invention will be described below with reference to FIG. 11. FIG. 11 is a diagram illustrating a schematic configuration of the TRP 20 according to one or more embodiments of the present invention. The TRP 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the TRP 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., RRC signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the TRP 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the TRP 20, and manages the radio resources.

(Configuration of User Equipment)

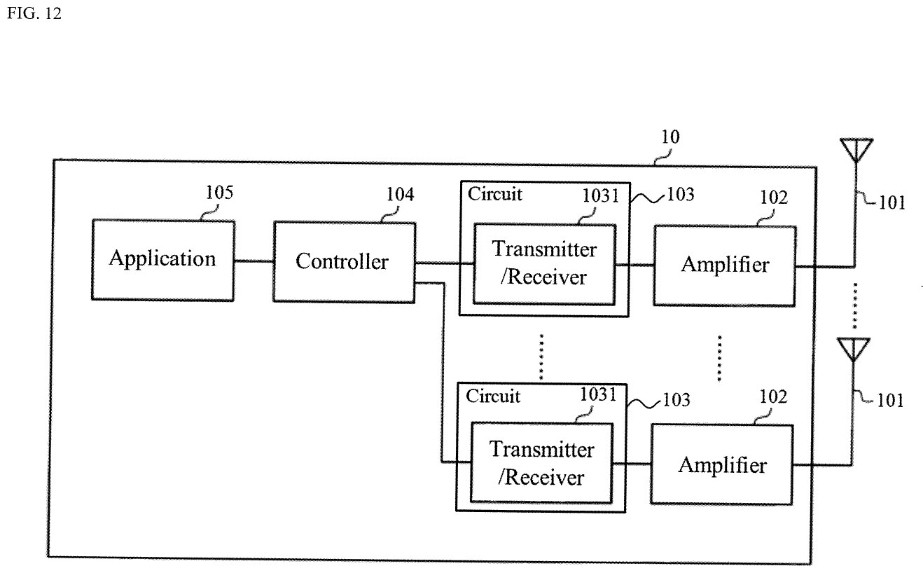

The UE 10 according to one or more embodiments of the present invention will be described below with reference to FIG. 12. FIG. 12 is a schematic configuration of the UE 10 according to one or more embodiments of the present invention. The UE 10 has a plurality of UE antennas 101, amplifiers 102, the circuit 103 comprising transceiver (transmitter/receiver) 1031, the controller 104, and an application 105.

As for DL, radio frequency signals received in the UE antennas 101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

### Another Example

One or more embodiments of the present invention may be used for each of the uplink and the downlink independently. One or more embodiments of the present invention may be also used for both of the uplink and the downlink in common.

Although the present disclosure mainly described examples of a channel and signaling scheme based on NR, the present invention is not limited thereto. One or more embodiments of the present invention may apply to another channel and signaling scheme having the same functions as NR such as LTE/LTE-A and a newly defined channel and signaling scheme.

Although the present disclosure mainly described examples of technologies based on the CSI-RS, the present invention is not limited thereto. One or more embodiments of the present invention may apply to another synchronization signal, reference signal, and physical channel such as Primary Synchronization Signal/Secondary Synchronization Signal (PSS/SSS) and Sounding Reference Signal (SRS).

Although the present disclosure described examples of various signaling methods, the signaling according to one or more embodiments of the present invention may be explicitly or implicitly performed.

Although the present disclosure mainly described examples of various signaling methods, the signaling according to one or more embodiments of the present invention may be the higher layer signaling such as the RRC signaling and/or the lower layer signaling such as the DCI and the MAC CE. Furthermore, the signaling according to one or more embodiments of the present invention may use a Master Information Block (MIB) and/or a System Information Block (SIB). For example, at least two of the RRC, the DCI, and the MAC CE may be used in combination as the signaling according to one or more embodiments of the present invention.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A user equipment (UE) comprising:
a receiver that receives, from a Transmission and Reception Point (TRP), multiple Demodulation Reference Signals (DMRSs) in adjacent resource blocks (RBs) of which a number is greater than a first predetermined value;
a processor that measures Channel State Information (CSI) using the received DMRSs; and
a transmitter that performs CSI reporting based on the CSI.

2. The UE according to claim 1, wherein the receiver receives, from the TRP, information that indicates the first predetermined value transmitted using Radio Resource Control signaling.

3. The UE according to claim 1, wherein the first predetermined value is indicated as an unit of precoding resource block groups (PRGs) or multiple PRGs.

4. The UE according to claim 1, wherein the first predetermined value is indicated as an unit of resource block groups (RBGs) or multiple RBGs.

5. The UE according to claim 1, wherein the multiple DMRS spans an entire reporting granularity.

6. The UE according to claim 1, wherein the processor measures the CSI for a whole band with the multiple DM-RS that are scheduled.

7. The UE according to claim 1, wherein the processor measures the CSI when total scheduled RBs are greater than a second predetermined value.

8. The UE according to claim 1, wherein the processor measures the CSI using part of the received DMRSs.

9. The UE according to claim 1, wherein the processor calculates a Channel Quality Indicator (CQI) and a Precoding Matrix Indicator (PMI) in each precoding RB (PBR) using the measured CSI.

10. The UE according to claim 1, wherein the processor calculates a CQI and a PMI based on a size of the each of PRGs in each precoding RB (PBR) using the measured CSI.

11. The UE according to claim 10, wherein the receiver receives, from the TRP, information that indicates the size transmitted using Physical Downlink Shared Channel (PDSCH).

12. The UE according to claim 10, wherein a size of a PRG of the each of the multiple DMRSs is smaller than a size of a PRG of a PDSCH corresponding to the multiple DMRSs.

13. The UE according to claim 1, wherein the processor calculates a CQI and a PMI based on a size of a subband notified by the TRP.

14. The UE according to claim 1, wherein the CSI reporting includes a frequency range determined based on a configured CSI reporting mode.

15. The UE according to claim 1, wherein the CSI reporting includes a frequency range determined based on scheduled DMRS resources.

16. The UE according to claim 1, wherein the CSI reporting includes a frequency range determined based on a scheduled PDSCH frequency range.

17. A method of Channel State Information (CSI) acquisition in a wireless communication system, the method comprising:
transmitting, from a Transmission and Reception Point (TRP) to a user equipment (UE), multiple Demodulation Reference Signals (DMRSs) in adjacent resource blocks (RBs) of which a number is greater than a first predetermined value;
measuring, with the UE, Channel State Information (CSI) using the received DMRSs; and
performing, with the UE, CSI reporting based on the CSI.

18. The method according to claim 17, further comprising:
transmitting, from the TRP to the UE, information that indicates the first predetermined value transmitted using Radio Resource Control signaling.

19. The method according to claim 17, wherein the first predetermined value is indicated as an unit of precoding resource block groups (PRGs) or multiple PRGs.

20. The method according to claim 17, wherein the first predetermined value is indicated as an unit of resource block groups (RBGs) or multiple RBGs.
